(19) United States
(12) Patent Application Publication
(10) Pub. No.: US 2009/0154782 A1
(43) Pub. Date: Jun. 18, 2009

(54) DUAL-MAGNIFY-GLASS VISUALIZATION FOR SOFT-COPY MAMMOGRAPHY VIEWING

(75) Inventors: Heidi Daoxian Zhang, Los Gatos, CA (US); Patrick Bernard Heffernan, Los Gatos, CA (US)

Correspondence Address: Three Palm Software LLC, 367 Penn Way, Los Gatos, CA, 95032, US

(73) Assignee: THREE PALM SOFTWARE, Los Gatos, CA (US)

(21) Appl. No.: 12/334,474

(22) Filed: Dec. 14, 2008

Related U.S. Application Data
(60) Provisional application No. 61/007,749, filed on Dec. 17, 2007.

(51) Int. Cl. G06K 9/00

(52) U.S. Cl. 382/128

(57) ABSTRACT

This invention provides a dual-magnify-glass viewing method for a mammography workstation. In particular, the invention includes a method that registers regions of interest on a pair of mammography images and provides a user interface to visualize the paired full resolution or magnified images in a synchronized style. The paired images are two views that can be either left and right bilateral mammogram views; two alternative projection mammogram views, or corresponding current and prior same mammogram views. The paired images can also be two views from different modalities, such as, X-ray and ultrasound images. This invention can be used to aid the radiologist to more effectively view mammography or other breast images.

### CROSS-REFERENCE TO RELATED APPLICATIONS

### U.S. PATENT DOCUMENTS

1. Provisional Application for Patent US60/906,305 “Image normalization for computer-aided detection, review and diagnosis” Mar. 12, 2007
2. Provisional Application for Patent US60/923,188 “Fast preprocessing algorithms for digital mammography CAD and workstation” Apr. 13, 2007
3. Provisional Application for Patent US60/930,132 “Communicative CAD workstation for assisting multi-modality breast imaging diagnosis” May 15, 2007
4. Provisional Application for Patent “User Interface and viewing Workflow for mammography workstation” Nov. 4, 2007

### OTHER PUBLICATIONS

5. Gaens etc. “Non-rigid multimodal image registration using mutual information” Proceedings of the 1^{st} international conference on medical image computing and computer-assisted intervention—MICCAI'98

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to the field of medical imaging systems. Particularly, the present invention relates to a method and apparatus for a soft-copy reading mammography interpretation workstation.

The U.S. patent Classification Definitions: 345/418 (class 345, Computer Graphics Processing and Selective Visual Display Systems, subclass 418 Computer Graphics Processing); 345/501 (class 345 Computer Graphics Processing and Selective Visual Display Systems, subclass 501 Computer Graphic Processing System); 378/37 (class 378, X-Ray or Gamma Ray System or Devices, subclass 37 Mammography); 382/173 (class 382 Image Analysis, subclass 294 Registering or aligning multiple images to one another).

Digital mammography images are very data-intensive. A standard 4-view study acquired on a digital system with a 50 μm detector can contain more than 140 MB of data. With the currently available monitors (5MP), only a portion of an image can be displayed at one time at full resolution (in actual pixels). An electronic magnifying glass that contains a portion of the mammographic images and pans over the images on the computer monitor can be provided to view the actual pixels. In mammography reading, it is normal practice to view the corresponding other view at same time for the purpose of comparison or correlation. The other view can be the bilateral view, alternative view or prior view. Currently, this correlation is done manually on the soft-copy reading workstation, which can be inefficient.

### BRIEF SUMMARY OF THE INVENTION

This invention provides the method that registers the regions of interest on a pair of mammography images and also provides the user interface to visualize the paired full resolution images in a synchronized style.

### BRIEF DESCRIPTIONS OF THE DRAWINGS

Dual-magnify-glass visualization for soft-copy mammography viewing

FIG. 1 shows the roaming dual-magnify-glass on bilateral left MLO (medio-lateral oblique) and right MLO views.

FIG. 2 shows the roaming dual-magnify-glass on bilateral left CC (cranial caudal) and right CC views.

FIG. 3 shows the roaming dual-magnify-glass on current and prior same view, for example, left MLO views.

FIG. 4 shows the fixed dual-magnify-glass on 1:1 pixel viewing of bilateral right MLO and left MLO views.

FIG. 5 shows the global registration algorithm for the paired views.

FIG. 6 shows the global registration calculations for a number of paired views.

FIG. 7 shows the local registration algorithm for the paired views.

### DETAILED DESCRIPTION OF THE INVENTION

This invention provides a dual-magnify-glass viewing method for a mammography workstation. The invention includes a method that registers regions of interest on a pair of mammography images. The invention also provides a user interface to visualize the paired full resolution or magnified images in a synchronized style.

The paired images can be two left and right bilateral mammogram views, which are typically the left breast of cranial caudal (LCC) view and the right breast of the cranial caudal (RCC) view and left breast of medio-lateral oblique (LMLO) view and the right breast of medio-lateral oblique (RMLO) view. The paired images can be two alternative projection mammogram views, which are typically the cranial caudal (CC) view and the medio-lateral oblique (MLO) view, either right breast or left breast. The paired images can be the corresponding current and prior same mammogram views, for example, current cranial caudal view and prior cranial caudal view, or current medio-lateral oblique view and the prior medio-lateral oblique view. The paired images can also be two views from different modalities, such as, X-ray and ultrasound images, or X-ray and MRI images.

By automatically registering the region of interest on different images and presenting the registered region in full resolution or magnified images in a synchronized style, this invention can be used to aid a radiologist to more effectively view mammography or other breast images.

Presentation of Paired Views:

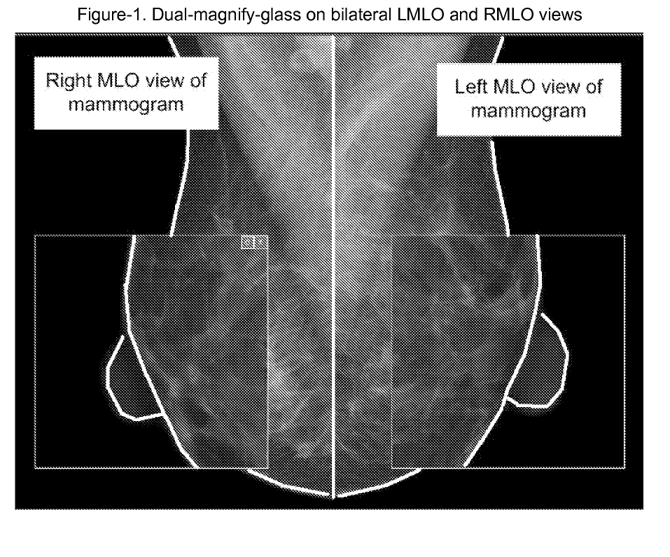

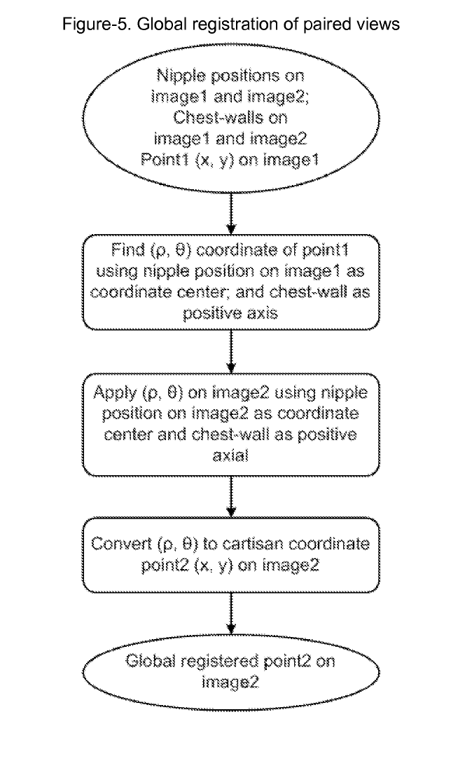

FIG. 1. Dual-magnify-glass on bilateral left MLO and right MLO views: the sequence to display the dual-magnify-glass on a paired bilateral views is: (1) The user uses a pointing device, such as a computer mouse, to provide the position of the magnify glass on one of the two bilateral views, i.e., left MLO (medial lateral oblique) view or right MLO view. (2) An electronic magnifying glass is displayed at the user defined position. (3) The correlated position on the other view is calculated using the algorithm described in FIG. 5-FIG. 7. (4) Then the second electronic magnify glass is automatically displayed at the calculated position on the second view. (5) The user can use the pointing device to move the first magnifying glass to a new position. (6) Again the correlated position on the second view is calculated using the algorithm described in FIG. 5-FIG. 7, and then the second electronic magnifying glass is automatically moved to the calculated position on the second view.

The same idea applies to bilateral left CC and right CC views.

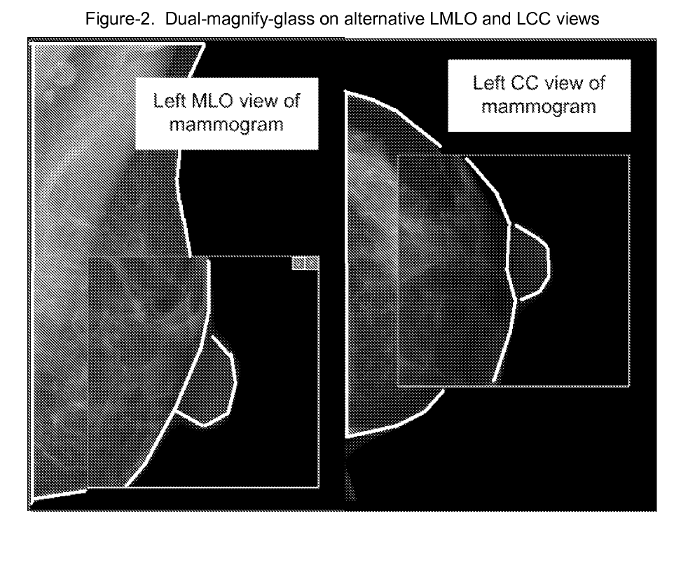

FIG. 2. Dual-magnify-glass on alternative LMLO and LCC views: the sequence to display the dual-magnify-glass on a paired alternative views is: (1) The user uses a pointing device, such as a computer mouse, to provide the position of the magnifying glass on one of two alternative views, i.e., left MLO (medial lateral oblique) view and left CC (cranial caudal) view. (2) An electronic magnifying glass is displayed at the user defined position. (3) The correlated position on the other view is calculated using the algorithm described in FIG. 5-FIG. 7. (4) Then the second electronic magnifying glass is automatically displayed at the calculated position on the second view. (5) The user can use the pointing device to move the first magnifying glass to a new position. (6) Again the correlated position on the second view is calculated using the algorithm described in FIG. 5-FIG. 7, and then the second electronic magnifying glass is automatically moved to the calculated position on the second view.

The same idea applies to alternative RMLO and RCC views.

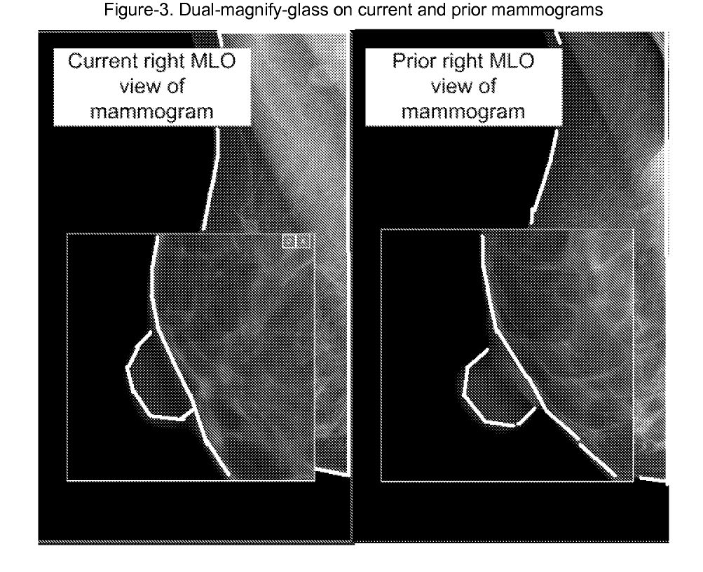

FIG. 3. Dual-magnify-glass on current and prior right MLO mammograms: the sequence to display the dual-magnify-glass on paired current and prior mammograms is: (1) The user uses a pointing device, such as a computer mouse, to provide the position of the magnifying glass on either the current or prior mammogram, i.e., the current right MLO (medial lateral oblique) or prior right MLO (medial lateral oblique) view. (2) An electronic magnifying glass is displayed at the user defined position. (3) The correlated position on the other view is calculated using the algorithm described in FIG. 5-FIG. 7. (4) Then the second electronic magnifying glass is automatically displayed at the calculated position on the second mammogram. (5) The user can use the pointing device to move the first magnifying glass to a new position. (6) Again the correlated position on the second view is calculated using the algorithm described in FIG. 5-FIG. 7, and then the second electronic magnify glass is automatically moved to the calculated position on the second mammogram.

The same idea applies to current LMLO and prior LMLO mammograms; current RCC and prior RCC mammograms; and current LCC and prior LCC mammograms.

The same idea also applies to a paired image set: between a mammogram and a set of (possibly 3D) ultrasound images or a set of (possibly 3D) MR images.

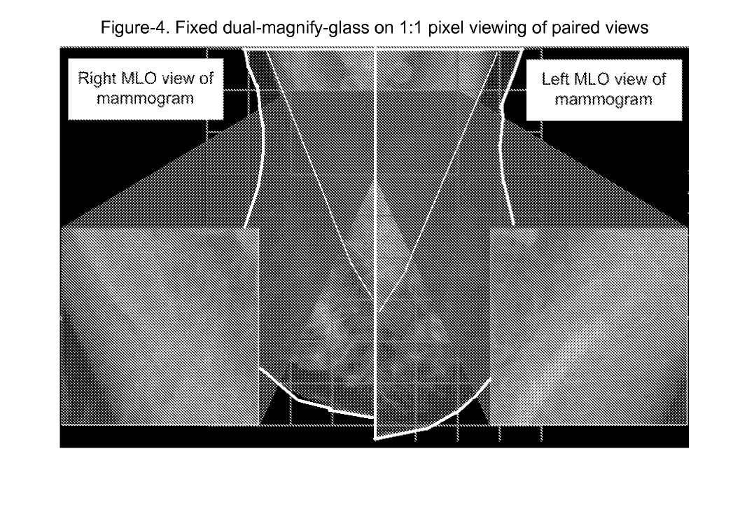

FIG. 4. Fixed dual-magnify-glass on 1:1 pixel viewing of bilateral RMLO and LMLO views: the sequence to display the dual-magnify-glass on the 1:1 pixel viewing of the paired bilateral views is: (1) The user enters the 1:1 pixel viewing mode (see reference 4). (2) A pair of electronic magnifying glasses is displayed at a fixed position, such as, opposite to the chestwall. (3) The Dual-magnify-glass visualization for soft-copy mammography viewing correlated ROIs (regions of interest) extracted from the paired images are displayed in the magnifying glasses. (4) The user can use the mouse wheel or arrow icons to scan through the images and to view the images region by region in pairs.

The same idea can be applied to bilateral RCC and LCC views, or alternative RMLO and RCC views as well as alternative LMLO and LCC views.

Registration of Paired Views:

The registration of the position on the second image to a position, either defined by the user or by automatic scanning, on the first image, includes two steps: global registration to get a rough estimation; followed by local registration to refine the result.

FIG. 5. Global registration of paired views: the basic idea of the global registration is to use breast image specific landmarks. In this invention, the landmarks are considered to be nipple position and chestwall (or pectoral muscle) orientation. The algorithm to detect nipple position and pectoral muscle orientation can be found in reference 2. Those landmarks are considered as input parameters to the global registration. The input to the global registration is a user defined point, (x₁, y₁) on the first image (coordinate). The output of the global registration is the “roughly” correlated point₂ (x₂,y₂) on the second image (coordinate). As shown in FIG. 5, the algorithm to calculate the point₂ from point₁ is based on the assumption that the second correlated point has the same distance to the nipple on the second image as the distance from the first point to the nipple on the first image. Similarly, the second correlated point has the same distance to the chestwall (or pectoral muscle) on the second image as the distance from the first point to the chestwall (or pectoral muscle) on the first image.

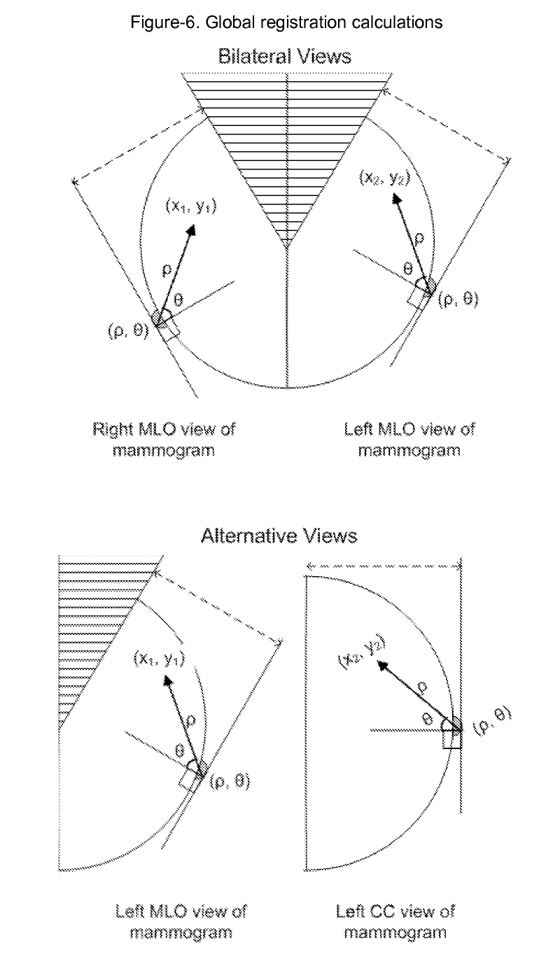

The specific calculation for bilateral views, alternative views and current/prior mammograms is shown in FIG. 6.

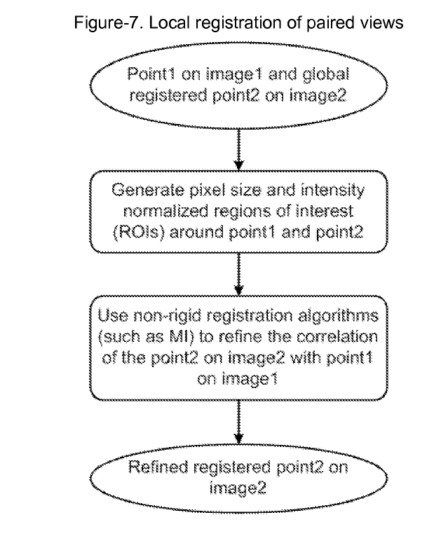

FIG. 7. Local registration of paired views: two steps are involved in the local registration: image pixel normalization followed by a non-rigid registration algorithm using mutual information. The image pixel normalization algorithm can be found in reference 1. The non-rigid registration algorithm can be found in a text book (reference 5).

1. A viewing method for a mammography workstation uses a dual-magnify-glass, comprises:
an algorithm that registers regions of interest on a pair of mammography images; and
a user interface to visualize the paired full resolution or magnified images in a synchronized style.

2. The method of claim 1, wherein the said dual-magnify-glass is two regions of interest of the paired images. The image in each region is presented in full or magnified resolution of the paired images.

3. The method of claim 1, wherein said a pair of images can be
left and right bilateral mammogram views;
two alternative projection mammogram views,
corresponding current and prior same mammogram views.
two views from different modalities, such as, X-ray and ultrasound images.

4. The method of claim 1, wherein the said “register regions”, comprises:
global registration algorithm; and
local registration algorithm.

5. The global registration algorithm in claim 4, comprises:
determine nipple position on the paired image1 and image2;
determine chest-wall of the paired image1 and image2;
input a point1 (x, y) on image1;
find (p, θ) coordinate of point1 using nipple position on image1 as coordinate center and the chest-wall as positive axis;
apply (p, θ) on image2 using nipple position on image2 as coordinate center and chest-wall as positive axial;
convert (p, θ) to Cartesian coordinate point2 (x, y) on image2;

6. The local registration algorithm in claim 4, comprises:
generate pixel size and intensity normalized regions of interest around point1 on image1 and around point2 on image2;
use non-rigid registration algorithms (such as mutual information) to refine the correlation of the point2 on image2 with point1 on image1.
The method of claim 1, wherein the said user interface to visualize the paired full resolution or magnified images, comprises a sequence of displaying the dual-magnify-glass on paired bilateral views:
the user uses a pointing device, such as a computer mouse, to provide the position of the magnify glass on one of the two bilateral views;
an electronic magnifying glass is displayed at the user defined position;
then the second electronic magnify glass is automatically displayed at the registered position on the other view;
the user can use the pointing device to move the first magnifying glass to a new position;
again the second electronic magnify glass is automatically moved to the registered position on the other view
